(19) United States
(12) Patent Application Publication
(10) Pub. No.: US 2013/0148329 A1
(43) Pub. Date: Jun. 13, 2013

(54) DIRECT-TYPE BACKLIGHT DEVICE AND DISPLAY DEVICE

(71) Applicants: Hao Zhou, Beijing (CN); Qing Ma, Beijing (CN); Daekeun Yoon, Beijing (CN); Fei Shang, Beijing (CN)

(72) Inventors: Hao Zhou, Beijing (CN); Qing Ma, Beijing (CN); Daekeun Yoon, Beijing (CN); Fei Shang, Beijing (CN)

(73) Assignee: BEIJING BOE OPTOELECTRONICS TECHNOLOGY CO., LTD., Beijing (CN)

(21) Appl. No.: 13/703,104

(22) PCT Filed: Sep. 5, 2012
(86) PCT No.: PCT/CN2012/081018

§ 371 Date: Dec. 10, 2012

(30) Foreign Application Priority Data
Sep. 7, 2011 (CN) 201120335822.7

(51) Int. Cl. G09F 13/04

(52) U.S. Cl. CPC G09F 13/04
USPC 362/97.1

(57) ABSTRACT

A direct-type backlight device and a display device having the direct-type backlight device are disclosed. The direct-type backlight device comprises: a backplane, a plurality of light-emitting units arranged on the backplane, and a diffusion plate over the light-emitting units, wherein at least one of the light-emitting units is provided at an upper end thereof with a transparent supporter for supporting the diffusion plate.

### TECHNICAL FIELD

The present disclosure relates to a direct-type LED backlight device and a display device.

### BACKGROUND

In a liquid crystal display screen, a backlight is an important technical factor involving the display effect of the display screen. With technology update and an increasingly high demand for TV appearances in the market, the liquid crystal display screens for TVs are at present developed toward a trend of narrow bezel. In the current field of backlight, an Light Enhancer Cap (LE-Cap, which is a light enhancer lens) technology, by adding an Light Enhancer Cap above an LED light source lamp, reduces the number of light source lamps, and reduces the light-mixing distance from light source lamps to a film material, so that the thickness of the direct-type backlight can be made thin. This meets the light-and-thin conception in developing a display screen.

As shown in FIG. 1 and FIG. 2, due to the comparatively large size of the screen, the intermediate portion of the backlight needs a certain number of lamp guides 101 to support a diffusion plate 102 and an optical module. The lamp guide 101 in the prior art is made of a non-light-transmissive material, and therefore it leads to that light cannot transmit through the positions where the tip ends of the lamp guides 101 are in contact with the diffusion plate 102, causing dark spots to emerge at the contact positions, and adversely affecting the subjective display effect of the display screen.

### SUMMARY

According to an embodiment of the present disclosure, there is provided a direct-type backlight device, comprising: a backplane, a plurality of light-emitting units arranged on the backplane, and a diffusion plate over the light-emitting units, wherein at least one of the light-emitting units is provided at an upper end thereof with a transparent supporter, for supporting the diffusion plate.

Preferably, the light-emitting unit is composed of a light source lamp and a Light Enhancer Cap, both the light source lamp and the Light Enhancer Cap being fixed on the backplane, and the light source lamp is disposed under the Light Enhancer Cap, and the transparent supporter is disposed on the Light Enhancer Cap.

Preferably, the supporter and the Light Enhancer Cap are in an integral structure.

Preferably, the light-emitting unit with the transparent supporter is located in an intermediate region of the backplane.

The light source lamp may be an LED lamp.

The direct-type backlight device may further comprise an optical module located on the diffusion plate, the optical module comprising a polarizing film, a prism film and a diffusion film.

According to an embodiment of the present disclosure, there is also provided a display device, comprising an above-described direct-type backlight device in accordance with an embodiment of the present disclosure.

In the direct-type backlight devices and display devices according to the embodiments of the present disclosure, by providing a transparent supporter at an upper end of a light-emitting unit, the emergence of a dark spot is avoided. Further, when the transparent supporter is integrally formed on a Light Enhancer Cap in a light-emitting unit, it is possible to reduce the number of parts and reduce the assembly steps.

### BRIEF DESCRIPTION OF THE DRAWINGS

FIG. 1 is a structural view of an existing direct-type backlight device;

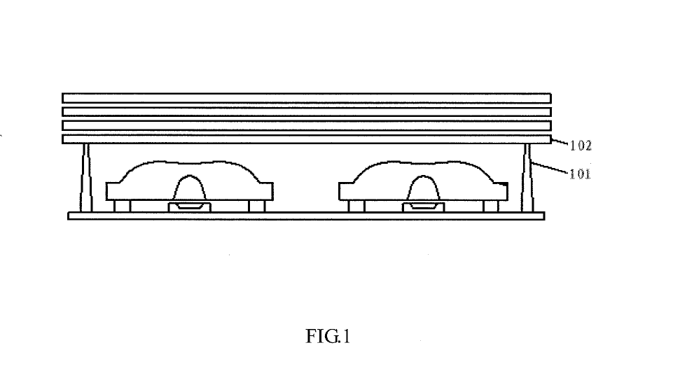

FIG. 2 is an illustration of an optical effect of an existing direct-type backlight device;

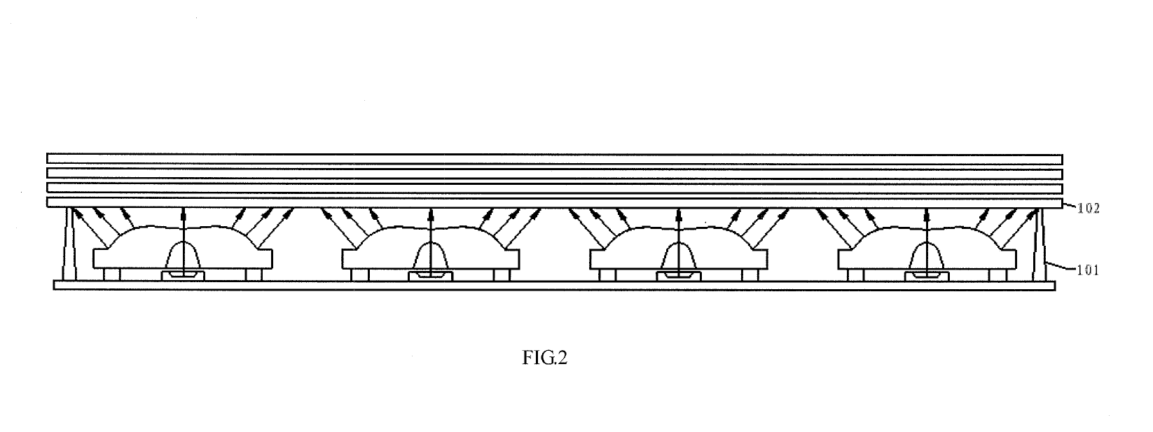

FIG. 3 is a structural view of a direct-type backlight device according to an embodiment of the present disclosure;

FIG. 4 is an illustration of an optical effect of a direct-type backlight device according to an embodiment of the present disclosure;

FIG. 5 is an illustration of another optical effect of a direct-type backlight device according to an embodiment of the present disclosure.

### DETAILED DESCRIPTION OF THE PREFERRED EMBODIMENTS

Below with reference to the accompanying figures, embodiments of the present disclosure will be described in detail.

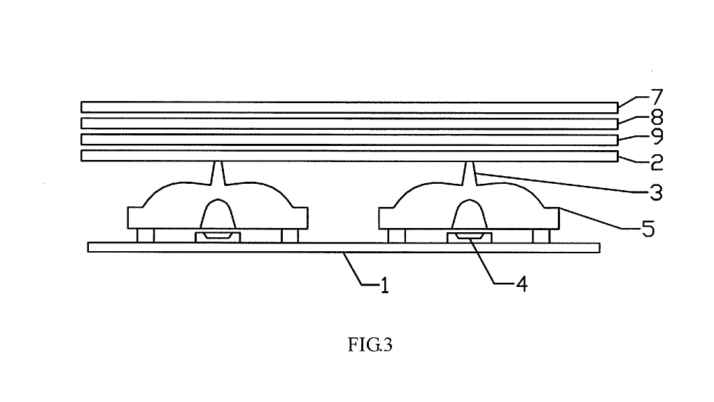

As shown in FIG. 3, a direct-type backlight device according to an embodiment of the present disclosure comprises a backplane 1, a plurality of light-emitting units arranged on the backplane 1, and a diffusion plate 2 over the light-emitting units. At least one of the light-emitting units is provided at an upper end thereof with a transparent supporter 3, and the transparent supporter 3 supports against the diffusion plate 2.

The direct-type backlight device may further comprise an optical module located on the diffusion plate 2, and the optical module may comprise a polarizing film 7, a prism film 8 and a diffusion film 9. For example, the diffusion plate from the bottom up comprises the diffusion film 9, the prism film 8 and the polarizing film 7 in order.

The light-emitting unit is composed of a light source lamp 4 and a Light Enhancer Cap 5. The light source lamp 4 may be an LED lamp. Both the light source lamp 4 and the Light Enhancer Cap 5 are fixed on the backplane 1, and the light source lamp 4 is disposed under the Light Enhancer Cap 5. The transparent supporter 3 is disposed on the Light Enhancer Cap 5.

In order to reduce the assembly steps, the transparent supporter 3 and the Light Enhancer Cap 5 may be formed as an integral structure, for example, by an integral-molding process.

In some examples, the transparent supporter 3 is located at an intermediate position at the top of the light-emitting unit, that is, the transparent supporter 3 is disposed at an intermediate position at the top of the Light Enhancer Cap 5, making light passing through the Light Enhancer Cap 5 project uniformly. Use of the transparent supporter 3 makes it possible for light to fully irradiate to the diffusion plate 2, and emergence of dark spots as in the existing structure can be avoided.

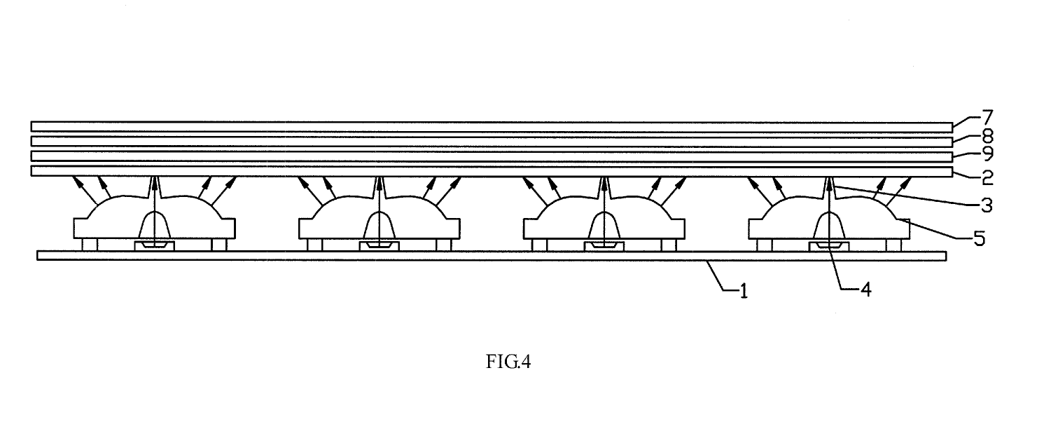

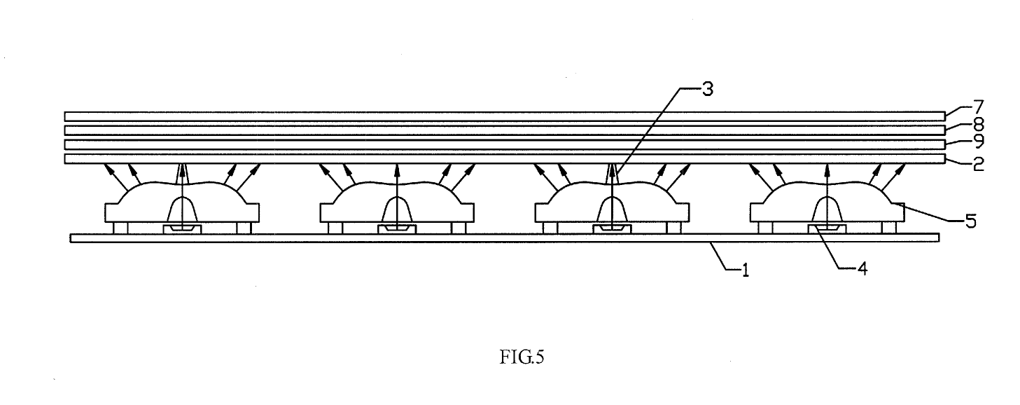

As shown in FIGS. 4-5, the transparent supporters may be arranged on the Light Enhancer Cap 5 continuously or at intervals, both achieving a desired effect.

In some examples, as long as the backlight module can be supported, the light-emitting units having the transparent supporters 3 are used in an amount as small as possible. Preferably, all the light-emitting units having the transparent supporters 3 are located in an intermediate region of the backplane, and the peripheral sides of the backplane may be supported by an outer bezel.

An embodiment of the present disclosure also provides a display device, which may be used for a pad computer, a display, a liquid crystal TV, etc. The display device comprises a direct-type backlight device in accordance with an embodiment of the present disclosure. The direct-type backlight device comprises a backplane 1, a plurality of light-emitting units arranged on the backplane 1, and a diffusion plate 2 over the light-emitting units. At least one of the light-emitting units is provided at an upper end thereof with a transparent supporter 3, and the transparent supporter 3 supports against the diffusion plate 2

The direct-type backlight device may further comprise an optical module located on the diffusion plate 2, and the optical module may comprise a polarizing film 7, a prism film 8 and a diffusion film 9. For example, the diffusion plate from the bottom up comprises the diffusion film 9, the prism film 8 and the polarizing film 7 in order.

The light-emitting unit may be composed of a light source lamp 4 and a Light Enhancer Cap 5. The light source lamp 4 may be an LED lamp. Both the light source lamp 4 and the Light Enhancer Cap 5 are fixed on the backplane 1, and the light source lamp 4 is disposed under the Light Enhancer Cap 5. The transparent supporter 3 is disposed on the Light Enhancer Cap 5.

In order to reduce the assembly steps, the transparent supporter 3 and the Light Enhancer Cap 5 may be formed as an integral structure, for example, by an integral-molding process.

In some examples, the transparent supporter 3 is located at an intermediate position at the top of the light-emitting unit, that is, the transparent supporter 3 is disposed at an intermediate position at the top of the Light Enhancer Cap 5, making light passing through the Light Enhancer Cap 5 project uniformly. The use of the transparent supporter 3 makes it possible for light to fully irradiate to the diffusion plate 2, and the emergence of dark spots as in the existing structure can be avoided.

As shown in FIGS. 4-5, the transparent supporters may be arranged on the Light Enhancer Cap 5 continuously or at intervals, both achieving a desired effect.

In some examples, as long as the backlight module can be supported, the light-emitting units having the transparent supporters 3 arc used in an amount as small as possible. Preferably, all the light-emitting units having the transparent supporters 3 are located in an intermediate region of the backplane, and the peripheral sides of the backplane may be supported by an outer bezel.

The above description is merely the preferred embodiments of the present disclosure, and the protection scope of the present disclosure is not limited thereto. In the technical scope of the present disclosure, variations or replacements which are easily conceived by any skilled who is familiar with the art, should be encompassed by the protection scope of the present disclosed technology. Therefore, the protection scope of the present disclosed technology should be defined by the protection scope of the claims.

1. A direct-type backlight device, comprising: a backplane, a plurality of light-emitting units arranged on the backplane, and a diffusion plate over the light-emitting units, wherein at least one of the light-emitting units is provided at an upper end thereof with a transparent supporter, and the transparent supporter supports against the diffusion plate.

2. The direct-type backlight device according to claim 1, wherein the light-emitting unit is composed of a light source lamp and a Light Enhancer Cap, both the light source lamp and the Light Enhancer Cap being fixed on the backplane, and the light source lamp is disposed under the Light Enhancer Cap, and the transparent supporter is disposed on the Light Enhancer Cap.

3. The direct-type backlight device according to claim 2, wherein the supporter and the Light Enhancer Cap are in an integral structure.

4-7. (canceled)

8. The direct-type backlight device according to claim 1, wherein the light-emitting unit with the transparent supporter is located in an intermediate region of the backplane.

9. The direct-type backlight device according to claim 2, wherein the light-emitting unit with the transparent supporter is located in an intermediate region of the backplane.

10. The direct-type backlight device according to claim 3, wherein the light-emitting unit with the transparent supporter is located in an intermediate region of the backplane.

11. The direct-type backlight device according to claim 2, wherein the light source lamp is an LED lamp.

12. The direct-type backlight device according to claim 3, wherein the light source lamp is an LED lamp.

13. The direct-type backlight device according to claim 1, further comprising an optical module located on the diffusion plate, the optical module comprising a polarizing film, a prism film and a diffusion film.

14. A display device, wherein the display device comprises a direct-type backlight device comprising: a backplane, a plurality of light-emitting units arranged on the backplane, and a diffusion plate over the light-emitting units, wherein at least one of the light-emitting units is provided at an upper end thereof with a transparent supporter, and the transparent supporter supports against the diffusion plate.

15. The display device according to claim 14, wherein the light-emitting unit is composed of a light source lamp and a Light Enhancer Cap, both the light source lamp and the Light Enhancer Cap being fixed on the backplane, and the light source lamp is disposed under the Light Enhancer Cap, and the transparent supporter is disposed on the Light Enhancer Cap.

16. The display device according to claim 15, wherein the supporter and the Light Enhancer Cap are in an integral structure.

17. The display device according to claim 14, wherein the light-emitting unit with the transparent supporter is located in an intermediate region of the backplane.

18. The display device according to claim 15, wherein the light-emitting unit with the transparent supporter is located in an intermediate region of the backplane.

19. The display device according to claim 16, wherein the light-emitting unit with the transparent supporter is located in an intermediate region of the backplane.

20. The display device according to claim 15, wherein the light source lamp is an LED lamp.

21. The display device according to claim 16, wherein the light source lamp is an LED lamp.

22. The display device according to claim 15, further comprising an optical module located on the diffusion plate, the optical module comprising a polarizing film, a prism film and a diffusion film.
